(19) United States
(12) Patent Application Publication
(10) Pub. No.: US 2024/0021822 A1
(43) Pub. Date: Jan. 18, 2024

(54) COMPOSITION FOR CATHODE ACTIVE MATERIAL FOR ALL-SOLID-STATE BATTERY INCLUDING COLLOIDAL SILICA, CATHODE ACTIVE MATERIAL AND MANUFACTURING METHOD THEREOF

(71) Applicants: Hyundai Motor Company, Seoul (KR); Kia Corporation, Seoul (KR); WONIK QnC CORPORATION, Gumi-Si (KR)

(72) Inventors: Je Sik Park, Seoul (KR); Sang Heon Lee, Yongin-si (KR); Sung Woo Noh, Seoul (KR); Jeong Hyun Seo, Daejeon (KR); Im Sul Seo, Jincheon-Gun (KR); Ju Yeong Seong, Seongnam-Si (KR); Chung Bum Lim, Suwon-Si (KR); Hyuk Chun Kwon, Gumi-Si (KR); Ho Chang Lee, Daegu (KR); In Gu Choi, Gumi-Si (KR); Ji Su Kim, Busan (KR)

(21) Appl. No.: 18/071,799

(22) Filed: Nov. 30, 2022

(30) Foreign Application Priority Data
Jul. 18, 2022 (KR) 10-2022-0088022

(51) Int. Cl. H01M 4/62; H01M 4/36; H01M 4/525

(52) U.S. Cl. CPC H01M 4/62; H01M 4/366; H01M 4/525; H01M 2004/028

(57) ABSTRACT

A cathode active material for an all-solid-state battery including colloidal silica, a cathode active material, and a manufacturing method thereof are disclosed. It may be possible to achieve an enhancement in dispersion in a sulfide-based all-solid-state battery by controlling powder properties while reducing interfacial resistance between an electrolyte and a cathode active material of the sulfide-based all-solid-state battery.

### CROSS-REFERENCE TO RELATED APPLICATION

This application claims priority, under 35 U.S.C. § 119(a), to Korean Patent Application No. 10-2022-0088022 filed on Jul. 18, 2022, the entire contents of which are incorporated herein by reference.

### BACKGROUND

In an all-solid-state battery constituted by a sulfide-based solid electrolyte and an oxide-based cathode active material, a coating layer made of an oxide or the like exhibiting lithium ion conductivity may be required in order to reduce interfacial resistance caused by chemical/electrochemical reaction.

To address the above-mentioned problem, LiNbO₃, Li₂ZrO₃, or the like may be considered as coating materials. Such coating materials may be used to manufacture a coated cathode in an ethanol solvent system through a method such as spray coating while using a raw material having the form of ethoxide. Although Nb may be the most stable among potential coating materials, Nb is a rare element limited in natural reserves. For this reason, coating materials are used in the form of a limitative compound such as expensive ethoxide. In this regard, coating materials are limitative. The above information disclosed in this Background section is only for enhancement of understanding of the background of the disclosure and therefore it may contain information that does not form the prior art that is already known to a person of ordinary skill in the art.

### SUMMARY

The following summary presents a simplified summary of certain features. The summary is not an extensive overview and is not intended to identify key or critical elements.

The present disclosure has been made in an effort to solve the above-described problems, and an object of the present disclosure is to achieve an enhancement in dispersion in a sulfide-based all-solid-state battery by controlling powder properties while reducing interfacial resistance between an electrolyte and an active material of the sulfide-based all-solid-state battery.

Objects of the present disclosure are not limited to the above-described objects, and other objects of the present disclosure not yet described will be more clearly understood by those skilled in the art in light of the following detailed description. In addition, objects of the present disclosure may be accomplished by the features defined in the appended claims and combinations thereof.

A new coating material, which is inexpensive while maintaining suitable battery characteristics, would be beneficial for mass production of an all-solid-state battery. In some implementations, relatively inexpensive P and Zr-based coatings may be used, a material having the same performance as Nb has not been developed yet. Furthermore, particle dispersion may be very important in manufacture of an all-solid-state battery due to characteristics of the all-solid-state battery in which the constituent elements of an electrode are mixed in a powder state and, as such, a cathode active material satisfying a desired particle dispersion degree may be required.

A composition for a cathode active material for an all-solid-state battery may include colloidal silica, an active material particle, and a solvent.

The colloidal silica may have an average diameter of about 1 to about 100 nm.

The active material particle may include at least one selected from a group consisting of a lithium nickel-aluminum-cobalt oxide (NCA), a lithium nickel-cobalt-manganese oxide (NCM), a lithium cobalt oxide (LCO), a lithium iron phosphate (LFP) compound, and a lithium manganese oxide (LMO).

The active material particle may include at least one lithium source selected from a group consisting of lithium carbonate (Li₂CO₃), lithium hydroxide (LiOH), and a combination thereof.

The solvent may include at least one selected from a group consisting of ethanol, water, isopropanol, ketone, butyl acetate, ethyl ether, and a combination thereof.

A cathode active material for an all-solid-state battery may include an active material particle, and a coating layer coating at least a portion of a surface of the active material particle and including Li₂SiO₃.

The coating layer may have a content of 0.1 to 10 parts by weight with respect to 100 parts by weight of the cathode active material.

An absolute zeta potential of the cathode active material may be 77 mV or more.

A coefficient of friction of the cathode active material may be 0.9 or less.

A manufacturing method of a cathode active material for an all-solid-state battery may include preparing a precursor solution including colloidal silica and a solvent, obtaining coating powder by adding an active material particle to the precursor solution, and thermally treating the coating powder, wherein the cathode active material includes the active material particle, and a coating layer including Li₂SiO₃ while coating at least a portion of a surface of the active material particle.

Other aspects and/or examples of the present disclosure are described below.

### BRIEF DESCRIPTION OF THE DRAWINGS

FIG. 1 is a sectional view showing a cathode active material for an all-solid-state battery;

FIG. 2 is a flowchart showing a manufacturing method of a cathode active material for an all-solid-state battery;

FIG. 3 is a graph depicting results of measurement for a coating layer on a cathode surface;

FIG. 4 is a reference view showing measurement of an angle of repose and a coefficient of friction;

FIGS. 5A, 5B, 5C, and 5D show results of experiments for measurement of coefficients of friction in an example and comparative examples;

FIG. 6A is a graph depicting initial charging/discharging curves of Example 1 and Comparative Example 1;

FIG. 6B is a graph depicting lifespans of Example 1 and Comparative Example 1;

FIG. 6C is a graph depicting discharge capacities of Example 1 and Comparative Example 1;

FIG. 7A is a graph depicting cycle characteristics of Example 1 and Comparative Example 2; and

FIG. 7B is a graph depicting cycle characteristics of Example 1 and Comparative Example 3.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The above and other objectives, features and advantages of the present disclosure will be more clearly understood from the following forms taken in conjunction with the accompanying drawings. However, the present disclosure is not limited to various forms disclosed herein, and may be modified into different forms. These forms are provided to thoroughly explain the disclosure and to sufficiently convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that, when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless indicated otherwise. Moreover, when such a range pertains to integer values, all integers including the minimum value to the maximum value are included, unless indicated otherwise.

A composition for a cathode active material for an all-solid-state battery according to the present disclosure may include colloidal silica, an active material particle, and a solvent.

Throughout the present disclosure, silica (e.g., colloidal silica) may be used as a coating precursor.

Colloidal silica, which may be a coating precursor, is inexpensive, as compared to niobium (Nb) used in certain implementations Colloidal silica is also a safe material. Colloidal silica, which has not the form of a complex compound, may be used as the only coating precursor for a battery and, as such, there is an advantage of excellent productivity.

The average diameter of the colloidal silica may be about 1 to about 100 nm. The colloidal silica has the form in which SiO₂ nanoparticles having an average diameter of about 1 to about 100 nm are stably dispersed in a solvent, and may form hydrogen bonds by silanol groups (OH groups) at a surface thereof while having characteristics such as hydrophilicity, absorptivity, a film forming property, etc. In accordance with these characteristics, the colloidal silica may be easily adsorbed to particles, like a surfactant, and, as such, the colloidal silica may achieve easy dispersion of the particles, thereby achieving an enhancement in coating coverage.

If the colloidal silica is applied to a cathode active material, as a coating material, uniform dispersion of slurry in manufacture of a battery may be achieved because the colloidal silica has a high degree of dispersion and a high coating rate.

Although the solvent is not limited to a specific type, the solvent may include at least one selected from the group consisting of ethanol, water, isopropanol, ketone, butyl acetate, ethyl ether, and/or a combination thereof. In some implementations, a water-based solvent is usable. In this case, dispersion of particles may be enhanced.

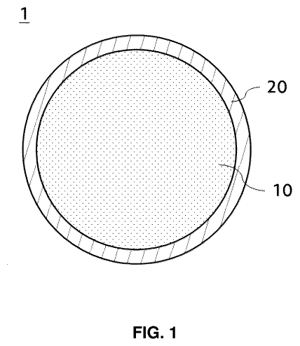

FIG. 1 is a sectional view showing a cathode active material for an all-solid-state battery.

Referring to FIG. 1, a cathode active material 1 may include an active material particle 10 and a coating layer 20 configured to coat at least a portion of a surface of the active material particle 10.

The active material particle 10 may include at least one selected from the group consisting of a lithium nickel-aluminum-cobalt oxide (NCA), a lithium nickel-cobalt-manganese oxide (NCM), a lithium cobalt oxide (LCO), a lithium iron phosphate (LFP) compound, and/or a lithium manganese oxide (LMO).

Although the active material particle 10 may be any one of materials widely used in the art to which the present disclosure pertains, the active material particle 10 may include, for example, Liₐ[NiₓCo_{y}Mn_{z}M_{1-x-y-z}]O₂ (here, 1.0≤a≤1.2, 0.0≤x≤1.0, 0.0≤z≤1.0, and 0.0≤1-x-y-z≤0.3).

The active material particle 10 may include at least one lithium source selected from the group consisting of lithium carbonate (Li₂CO₃), lithium hydroxide (LiOH), and/or a combination thereof.

In some active material particle(s), a separate lithium source may be added to the active material particle. The lithium source, which may be, for example, a Li ethoxide or the like, may be a flammable and corrosive material and, as such, there is a problem in that it is difficult to handle the lithium source in the atmosphere and, as such, productivity is low. In some other implementations, however, lithium carbonate (Li₂CO₃), lithium hydroxide (LiOH), or the like residual at a surface of an active material particle may be used as a lithium source when a cathode active material is manufactured and, as such, productivity may be improved. In addition, the production cost of the batteries may be reduced.

The coating layer 20 may include Li₂SiO₃.

If SiO₂-based coating is applied to a cathode active material, use of a complex precursor or a complex step is involved in many cases, as in a sol-gel method using tetraethyl orthosilicate (Si(OC₂H₅)₄: TEOS) or atomic layer deposition (ALD). TEOS, which may be used as a raw material for formation of a coating layer including SiO₂, may be a material that is difficult to handle in the atmosphere because TEOS is flammable and, as such, there is a problem of low productivity. On the other hand, colloidal silica has the form of SiO₂ of a stable phase and, as such, does not involve the above-described problems. In addition, colloidal silica uses water as a solvent and, as such, is safe in terms of handling and process. Colloidal silica is also used in various industries and, as such, has an advantage in terms of mass production.

Coated colloidal silica enhances dispersion of cathode particles and, as such, uniform slurry and a uniform electrode may be manufactured. In an example, the coating layer 20 including Li₂SiO₃ may enhance chemical/electrochemical stability at an interface between a cathode active material and a solid electrolyte, thereby enhancing durability of the product.

The content of the coating layer 20 may be about 0.1 to about 10 parts by weight (e.g., about 0.5 to about 4 parts by weight), with respect to about 100 parts by weight of the cathode active material 1. If the content of the coating layer 20 is less than about 0.5 parts by weight, insufficient coating may be formed on the surface of the active material and, as such, there may be a problem of an insufficient coating rate. On the other hand, if the content of the coating layer 20 is more than about 4 parts by weight, the coating layer 20 may be excessively thickly formed and, as such, the lithium ion conductivity may decrease, thereby resulting in an increase in surface resistance.

The cathode active material may have an absolute zeta potential of about 77 mV or more.

The coefficient of friction of the cathode active material including the coating layer may be about 0.9 or less, (e.g., about 0.7 or less). If the coefficient of friction is more than about 0.9, frictional force between particles may be excessively high and, as such, there may be a disadvantage in terms of dispersion. If the coefficient of friction is about 0.9 or less (e.g., about 0.7 or less), frictional force is reduced and, as such, there is an advantage in terms of dispersion.

Hereinafter, a manufacturing method of the cathode active material 1 for the all-solid-state battery will be described in detail.

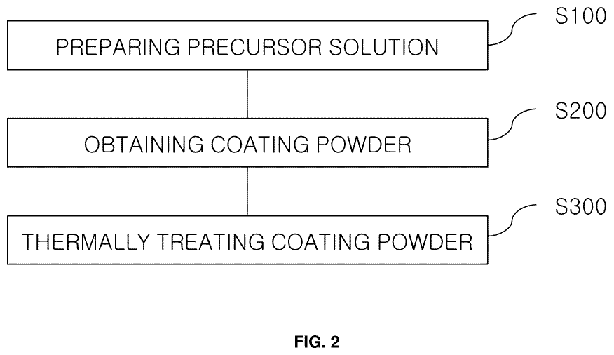

FIG. 2 is a flowchart showing a manufacturing method of a cathode active material for an all-solid-state battery. Referring to FIG. 2, the manufacturing method of the cathode active material for the all-solid-state battery may include preparing a precursor solution including colloidal silica and a solvent (S100), obtaining coating powder by adding an active material particle to the precursor solution (S200), and thermally treating the coating powder (S300). The cathode active material may include the active material particle, and a coating layer including Li₂SiO₃ while coating at least a portion of a surface of the active material particle.

In some implementations, a cathode active material may be manufactured by adding a lithium source and, as such, manufacture thereof may be more complex and productivity may be low, as compared to one or more examples described herein. The problems described above may be addressed by eliminating or reducing the process of adding a lithium source.

Step S300 may be performed for about 0.5 to about 3 hours at about 100 to about 700° C.

Step S300 may include drying the coating powder. Alternatively, or additionally, the drying may be performed prior to Step S300.

Hereinafter, the present disclosure will be described in detail with reference to the following example and comparative examples. However, the aspects of the present disclosure are not limited to the following examples.

### Example 1 and Comparative Examples 1 to 3

### Example 1

Residual lithium remaining at a surface of an active material was used as a lithium source material, and colloidal silica was used as a silicon precursor material. A composition for coating was prepared by adding the materials as described above to a solvent, that is, ethanol and agitating the resultant mixture (S100). The lithium source material and the silicon precursor material were added in a stoichiometric content corresponding to about 0.5% by weight of a content of a coating layer in a finally-obtained complex cathode active material. The content of the residual lithium was varied in accordance with the kind of the cathode active material and the manufacturing procedure. The coating procedure was performed after measuring an amount of the residual lithium through analysis. If the amount of residual lithium is very low or a thicker coating layer is required, various lithium sources may be additionally added in accordance with a solvent system.

After sufficient dispersion of the coating solution mixed with the coating source using a method such as sonication, the cathode active material was added to the coating solution. As the cathode active material, a compound expressed by Li[Ni_{0.75}Co_{0.1}Mn_{0.15}]O₂ was used. The coating composition with the cathode active material added thereto was stirred for about 1 hour, and was dried in a vacuum oven at about 120° C., thereby completely removing an organic solvent therefrom (S200).

The resultant product was thermally treated at about 330° C. for about 1 hour in an oxygen atmosphere, thereby completing a complex cathode active material (S300).

### Comparative Example 1

A cathode active material formed with no coating layer was determined as Comparative Example 1. The cathode active material is Li[Ni_{0.75}Co_{0.1}Mn_{0.15}]O₂.

### Comparative Example 2

A complex cathode active material was manufactured under the same condition and using the same method as Example 1, except that Nb ethoxide (Nb₂(C₁₀H₂₅O₅)₁₀) was used as a niobium source material, and ethanol was used as a solvent.

### Comparative Example 3

A complex cathode active material was manufactured under the same condition and using the same method as Example 1, except that Zr propoxide (Zr(OCH₂CH₂CH₃)₄) was used as a zirconium source material, and ethanol was used as a solvent.

### Experimental Example 1: Experiment for Measurement of Zeta Potential

Experiments for measurement of zeta potentials of cathode active materials manufactured in Example 1 and Comparative Examples 1 to 3 were performed. Results of measurement are shown in Table 1.

TABLE 1

| Category | Zeta Potential (mV) |
|---|---|
| Example 1 | −79.2 |
| Comparative Example 1 | −16.9 |
| Comparative Example 2 | −75.2 |
| Comparative Example 3 | −62.2 |

“Zeta potential” may be an index representing a degree of surface charging of particles suspended or dispersed in a medium (water and/or an organic solvent). If an electric field is externally applied to the particles, the particles move in a direction opposite to a sign of surface potential thereof (electrophoresis). In this case, “zeta potential” may be a value calculated based on the intensity of the electric field corresponding to the velocity of movement of the particles, to which the electric field is applied, hydrodynamic effects (viscosity and permittivity of a solvent), etc. For example, dispersion stability of particles suspended in a liquid may be determined through an absolute zeta potential.

As the absolute zeta potential of electrochemical active material particles increases, repulsive force between the particles may increase and, as such, the degree of dispersion and the degree of dispersion maintenance of the particles may also increase. On the other hand, if the absolute zeta potential of electrochemical active material particles approximates to 0, agglomeration and sedimentation of the particles may occur easily due to electrostatic attraction between the particles, and, as such, suspension of the particles in an aqueous solution or an organic solution may be unstable.

Referring to Table 1, the absolute zeta potential of Example 1 is greater than those of Comparative Examples. This means that dispersion of Example 1 is enhanced when Example 1 is compared with Comparative Examples.

### Experimental Example 2: Experiment for Formation of Coating Layer

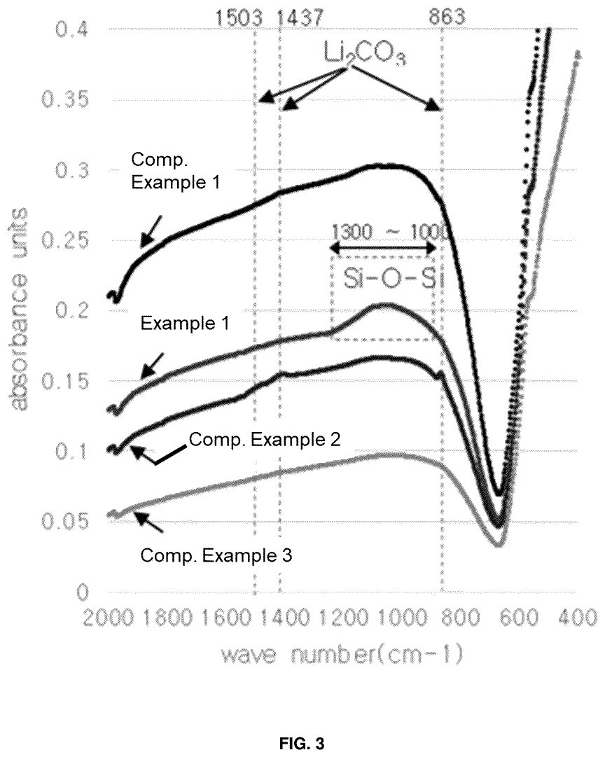

Experiments for formation of coating layers of cathode active materials manufactured in Example 1 and Comparative Examples 1 to 3 were performed. Results of measurements are shown in FIG. 3.

FIG. 3 is a graph depicting results of measurement for a coating layer on a cathode surface in Example 1 and Comparative Examples 1 to 3. Referring to FIG. 3, in Example 1, Si—O—Si bonds are observed in a wave number region of about 1,000 to about 1,300 cm⁻¹ and, as such, silicon oxide is coated. In addition, no peak of residual lithium is observed in Example 1, unlike Comparative Examples 1 and 2.

Thus, a coating layer is formed in accordance with bonding between the residual lithium on the active material surface and the silicon precursor in Example 1.

### Experimental Example 3: Experiment for Measurement of Coefficient of Friction

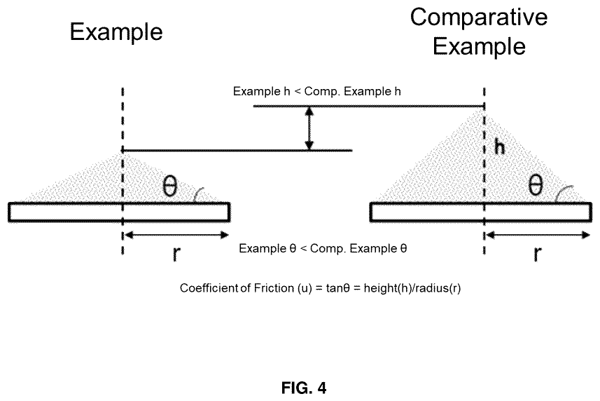

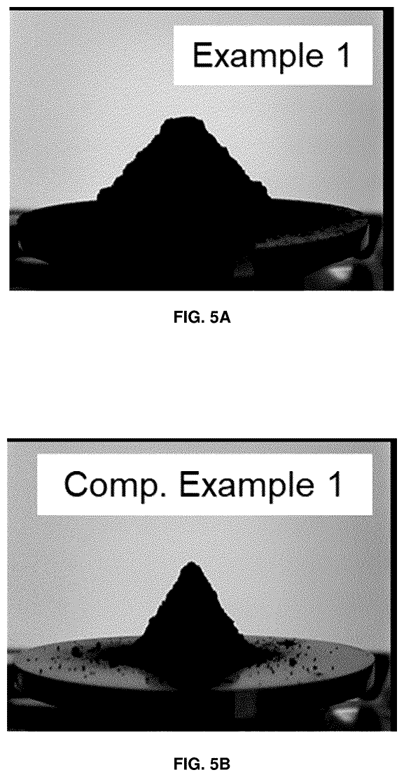

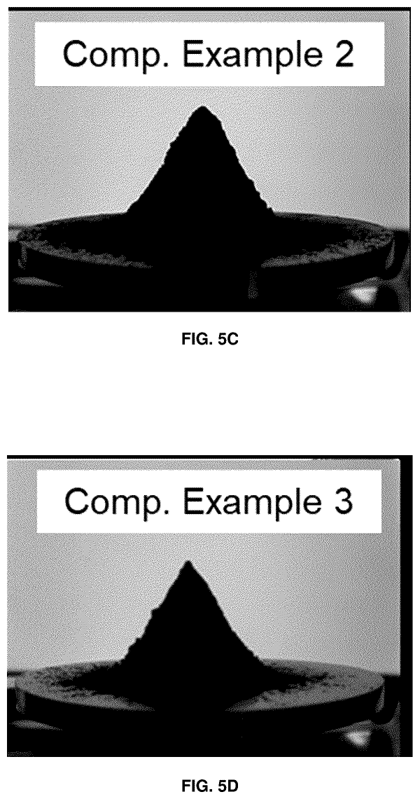

Experiments for measurement of coefficients of friction of the cathode active materials manufactured in Example 1 and Comparative Examples 2 and 3 were performed. Results of the experiments are shown in Table 2 and FIGS. 4, 5A, 5B, 5C, and 5D.

TABLE 2

| | Measurement of Angle of Repose | | | | |
|---|---|---|---|---|---|
| | First | Second | Third | | Coefficient of |
| Category | Time | Time | Time | Average | Friction (u) |
| Example 1 | 33.02 | 32.43 | 33.44 | 32.96 | 0.648 |
| Comp. Example 1 | 42.49 | 50.86 | 54.88 | 49.41 | 1.167 |
| Comp. Example 2 | 47.59 | 44.61 | 44.40 | 44.51 | 0.979 |
| Comp. Example 3 | 46.27 | 42.10 | 45.63 | 44.66 | 0.988 |

FIG. 4 is a reference view showing measurement of an angle of repose and a coefficient of friction. Referring to FIG. 4, a coefficient of friction u may be measured through measurement of an angle of repose 8. As an angle of repose 8 increases, a height h also increases and, as such, frictional force between particles also increases. On the other hand, as an angle of repose 8 decreases, a height h also decreases and, as such, frictional force between particles also decreases.

FIGS. 5A to 5D show results of experiments for measurement of coefficients of friction in the example and comparative examples. Referring to FIGS. 5A to 5D, the angle of repose in Example 1 is smaller than those of Comparative Examples 1 to 2 because a height h of Example 1 is smaller than those of Comparative Examples 1 to 3. This is because the coefficient of friction in Example 1 is smaller than those of Comparative Examples 1 to 3 and, as such, frictional force between particles is smaller in Example 1.

Thus, powder properties of Example 1 are improved in comparison with the powder properties of Comparative Examples 1 to 3.

### Experimental Example 4: Comparison of All-Solid-State Battery Characteristics

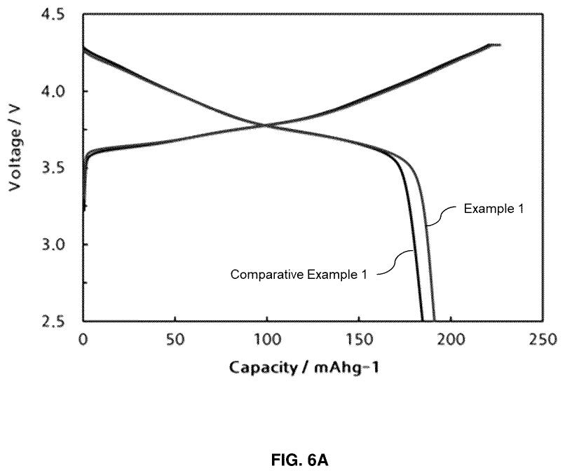

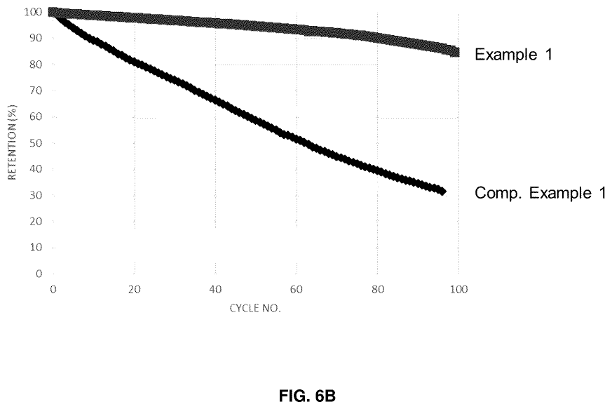

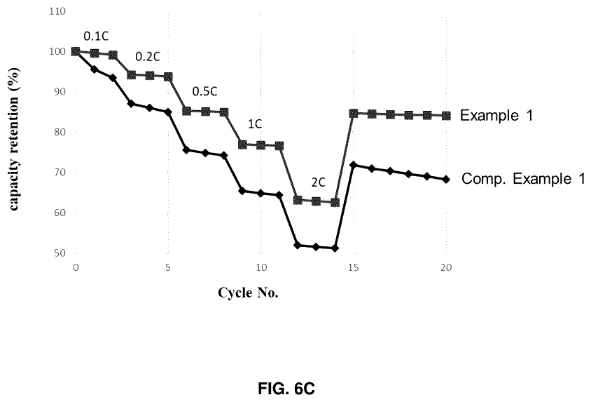

Experiments for measurement of all-solid-state battery characteristics of cathodes respectively including cathode active materials manufactured in Example 1 and Comparative Example 1 were performed. Results of the experiments are shown in Table 3 and FIGS. 6A to 6C.

TABLE 3

| | | Charge | Discharge | | Retention |
|---|---|---|---|---|---|
| | Coating | Capacity | Capacity | Efficiency | @50^{th} |
| Category | Layer | (mAh/g) | (mAh/g) | (%) | Cycle (%) |
| Example 1 | Li₂SiO₃ | 225.5 | 191.2 | 84.8 | 94.8 |
| Comp. | — | 223.0 | 184.8 | 82.9 | 59.4 |
| Example 1 | | | | | |

FIG. 6A is a graph depicting initial charging/discharging curves of Example 1 and Comparative Example 1. FIG. 6B is a graph depicting lifespans of Example 1 and Comparative Example 1. FIG. 6C is a graph depicting discharge capacities of Example 1 and Comparative Example 1.

Referring to Table 3 and FIGS. 6A to 6C, Example 1 including an Li₂SiO₃ coating layer provides enhanced properties in terms of all battery characteristics in comparison with the properties of Comparative Example 1.

### Experimental Example 5: Comparison of Coating Robustness

Experiments for comparison of chemical stability of sulfide-based solid-state electrolytes of cathode active materials manufactured in Example 1 and Comparative Example 1 were performed. Results of the experiments are shown in Table 4.

TABLE 4

| | Conductivity of Cathode | | Conductivity of Cathode | | | |
|---|---|---|---|---|---|---|
| | Active Material (δF) | | Active Material (δ24) | | Conductivity Reduction | |
| | (Unit: mS/cm) | | (Unit: mS/cm) | | Rate [(δ24 − δF/δF] | |
| | Electron | Ion | Electron | Ion | Electron | Ion |
| Category | Conductivity | Conductivity | Conductivity | Conductivity | Conductivity | Conductivity |
| Example 1 | 3.1E−04 | 6.6E−04 | 3.5E−04 | 8.6E−04 | 11.82 | 30.37 |
| Comp. | 3.1E−04 | 1.9E−04 | 3.6E−04 | 1.2E−04 | −18.10 | −36.25 |
| Example 1 | | | | | | |

Referring to Table 4, electron conductivity and ion conductivity of Example 1 are improved in comparison with those of Comparative Example 1.

### Experimental Example 6: Comparison of Cycle Characteristics

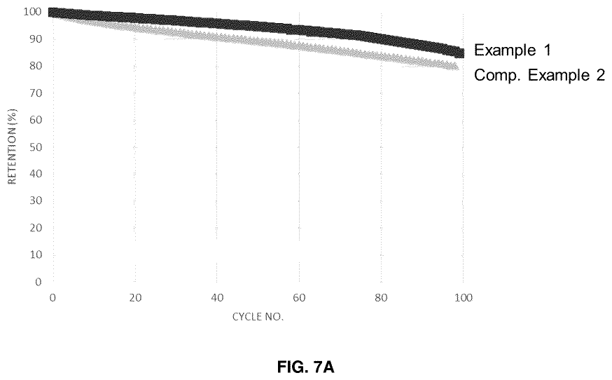

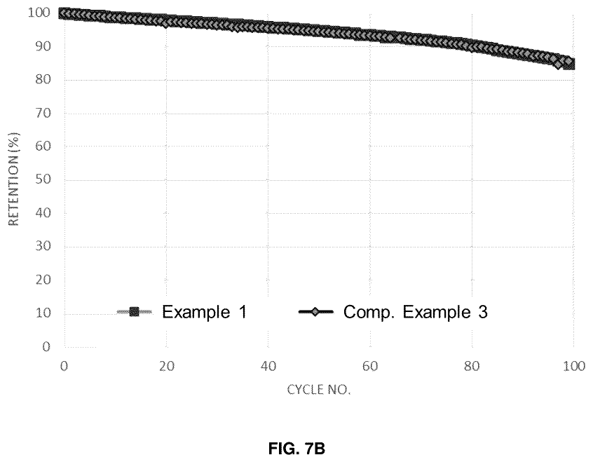

Experiments for measurement of cycle characteristics of all-solid-state batteries respectively including cathodes including cathode active materials manufactured in Example 1 and Comparative Examples 1 to 3 were performed. Results of the experiments are shown in Table 5 and FIGS. 7A and 7B.

TABLE 5

Capacity Retention (%)

| | | Comp. | Comp. | Comp. |
|---|---|---|---|---|
| Cycle No. | Example 1 | Example 1 | Example 2 | Example 3 |
| 10^{th} | 98.8 | 89.9 | 96.8 | 98.6 |
| 20^{th} | 97.9 | 81.8 | 94.6 | 97.5 |
| 50^{th} | 94.8 | 59.4 | 89.4 | 94.4 |
| 100^{th} | 86.3 | 31.3 | 80.6 | 86.0 |

Retention capacity (capacity retention) is a value representing how much capacity remains with respect to an initial capacity after charging and discharging are repeated under the same charging/discharging conditions in terms of, for example, temperature, voltage, current, etc. It may be possible to identify side reaction and degradation of an active material varying in repeated electrochemical reaction based on whether or not a coating layer is present or based on the type of the coating layer.

FIG. 7A is a graph depicting cycle characteristics of Example 1 and Comparative Example 2. FIG. 7B is a graph depicting cycle characteristics of Example 1 and Comparative Example 3. Referring to Table 5 and FIGS. 7A and 7B. Example 1 exhibits an improved retention capacity in all cycles in comparison with those of Comparative Examples 2 and 3.

As such, through the above-described results, durability of the all-solid-state battery is enhanced.

In accordance with the one or more examples of the present disclosure, it may be possible to obtain a cathode active material using inexpensive and safe colloidal silica.

In accordance with the one or more examples of the present disclosure, it may be possible to obtain a cathode active material capable of enhancing dispersion between particles while being capable of using a water-based solvent.

In accordance with the one or more examples of the present disclosure, if the cathode active material having the above-described characteristics is applied to an all-solid-state battery, it may be possible to greatly increase the lifespan of the all-solid-state battery. In addition, the all-solid-state battery may provide improved safety and cost reduction of a coating process while providing high-performance characteristics.

Effects attainable by the one or more examples of the present disclosure are not limited to the above-described effects, and other effects of the present disclosure not yet described will be more clearly understood by those skilled in the art from the appended claims.

Various examples have been described in detail with reference to example figures and experiment results. However, it will be appreciated by those skilled in the art that changes may be made in these examples without departing from the principles of the invention.

What is claimed is:

1. A composition for a cathode active material comprising:
colloidal silica;
an active material particle; and
a solvent.

2. The composition according to claim 1, wherein the colloidal silica has an average diameter of about 1 to about 100 nm.

3. The composition according to claim 1, wherein the active material particle comprises at least one of: a lithium nickel-aluminum-cobalt oxide (NCA), a lithium nickel-cobalt-manganese oxide (NCM), a lithium cobalt oxide (LCO), a lithium iron phosphate (LFP) compound, a lithium manganese oxide (LMO), or any combination thereof.

4. The composition according to claim 1, wherein the active material particle comprises a lithium source on a surface of the active material particle, and
wherein the lithium source comprises at least one of: lithium carbonate (Li₂CO₃), lithium hydroxide (LiOH), or any combination thereof.

5. The composition according to claim 1, wherein the solvent comprises at least one of: ethanol, water, isopropanol, ketone, butyl acetate, ethyl ether, or any combination thereof.

6. A cathode active material comprising:
an active material particle; and
a coating layer covering at least a portion of a surface of the active material particle,
wherein the coating layer comprises Li₂SiO₃.

7. The cathode active material according to claim 6, wherein the active material particle comprises at least one of: a lithium nickel-aluminum-cobalt oxide (NCA), a lithium nickel-cobalt-manganese oxide (NCM), a lithium cobalt oxide (LCO), a lithium iron phosphate (LFP) compound, a lithium manganese oxide (LMO), or any combination thereof.

8. The cathode active material according to claim 6, wherein a content of the coating layer is about 0.1 to about 10 parts by weight with respect to about 100 parts by weight of the cathode active material.

9. The cathode active material according to claim 6, wherein an absolute zeta potential of the cathode active material is about 77 mV or more.

10. The cathode active material according to claim 6, wherein a coefficient of friction of the cathode active material is about 0.9 or less.

11. A method for manufacturing a cathode active material of an all-solid-state battery comprising:
preparing a precursor solution comprising colloidal silica and a solvent;
obtaining a coating powder by adding an active material particle to the precursor solution;
thermally treating the coating powder; and
forming the cathode active material by forming a coating layer covering at least a portion of a surface of the active material particle,
wherein the coating layer comprises Li₂SiO₃.

12. The method according to claim 11, wherein the colloidal silica has an average diameter of about 1 to about 100 nm.

13. The method according to claim 11, wherein the solvent comprises at least one of: ethanol, water, isopropanol, ketone, butyl acetate, ethyl ether, or any combination thereof.

14. The method according to claim 11, wherein the active material particle comprises at least one of: a lithium nickel-aluminum-cobalt oxide (NCA), a lithium nickel-cobalt-manganese oxide (NCM), a lithium cobalt oxide (LCO), a lithium iron phosphate (LFP) compound, a lithium manganese oxide (LMO), or any combination thereof.

15. The method according to claim 11, wherein the active material particle comprises a lithium source on the surface of the active material particle, and
wherein the lithium source comprises at least one of: lithium carbonate (Li₂CO₃), lithium hydroxide (LiOH), or any combination thereof.

16. The method according to claim 11, wherein a content of the coating layer is about 0.1 to about 10 parts by weight with respect to about 100 parts by weight of the cathode active material.

17. The method according to claim 11, wherein an absolute zeta potential of the cathode active material is about 77 mV or more.

18. The method according to claim 11, wherein a coefficient of friction of the cathode active material is about 0.9 or less.
